(19) United States
(12) Patent Application Publication
(10) Pub. No.: US 2026/0125504 A1
(43) Pub. Date: May 7, 2026

(54) ORGANOSILICONE MATERIAL AND LATEX COMPOSITION COMPRISING THE SAME

(71) Applicant: Momentive Performance Materials Inc., Niskayuna, NY (US)

(72) Inventors: Debdeep Maity, West Bengal (IN); Sashivinay Kumar Gaddam, Telangana (IN); Vinu Krishnan Appukuttan, Bangalore (IN); Bhanu Pratap, Bihar (IN); Yogesh Digamber Marathe, Maharashtra (IN); Yogesh Tiwary, Bangalore (IN); Karthikeyan Sivasubramanian, Bangalore (IN)

(21) Appl. No.: 19/377,326

(22) Filed: Nov. 3, 2025

(30) Foreign Application Priority Data
Nov. 4, 2024 (IN) 202411084014

(51) Int. Cl. C08F 290/14; C08F 2/24; C08G 77/00; C08G 77/04; C08K 3/22; C08K 3/26; C08K 5/17; C08K 5/5435; C09D 5/02; C09D 7/20; C09D 7/43; C09D 7/45; C09D 7/61; C09D 7/63; C09D 155/00

(52) U.S. Cl. CPC C08F 290/148; C08F 2/24; C08K 3/22; C08K 5/17; C08K 5/5435; C09D 5/025; C09D 7/20; C09D 7/43; C09D 7/45; C09D 7/61; C09D 7/63; C09D 155/005; C08G 77/045; C08G 77/70; C08K 2003/2241; C08K 2003/265

(57) ABSTRACT

An organo-functional silicone is shown and described herein. The organo-functional silicone comprises an acrylate/methacrylate functional group and a polyalkyleneoxide functional group. The organo-functional silicone is water dispersible and may be reacted with a free-radical polymerizable monomer under conditions to form a latex emulsion.

### CROSS-REFERENCE TO RELATED APPLICATIONS

This application claims priority to and the benefit of India Provisional Application No. 202411084014, titled “ORGANOSILICONE MATERIAL AND LATEX COMPOSITION COMPRISING THE SAME,” filed on Nov. 4, 2024, the entire disclosure of which is incorporated herein by reference.

### FIELD OF INVENTION

The present invention relates to an organic-modified silicone, compositions, copolymers, and emulsions comprising the same. In particular, the present invention relates to acrylate-functional silicones and compositions comprising the same. The acrylate-functional silicones can be employed to form copolymers such as, for example, latex copolymers suitable for use in a variety of applications and compositions.

### BACKGROUND

Paints based on conventional acrylic latexes have limited physical properties with respect to, for example, hydrophobicity, elastomeric properties, efflorescence, water vapor permeability, durability and the like. The addition of siloxanes to latex compositions may improve one or more of those properties. While siloxanes can be added to the formulation, it can be particularly beneficial to incorporate the siloxane material as a monomer during polymerization of the acrylic latex to achieve greater benefits. It is, however, difficult to incorporate acrylate-functional silicone monomers into the acrylic latex polymer made using emulsion polymerization process due to the hydrophobic nature of many acrylic-functional siloxanes.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is an organic-modified silicone. In aspects and embodiments, the organic-modified silicone is an acrylate-functional silicone that is free radical polymerizable with other polymerizable monomers. The organic-modified silicone is water dispersible and suitable for use in forming an emulsion. The acrylate-functional silicone may be employed to form a latex copolymer suitable for use in a variety of applications such as, but not limited to, coatings, adhesives, sealants, personal care formulations, and the like.

In one aspect, provided is a An organo-functional silicone monomer of the formula (I):

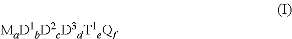

where:
M is R¹(R²)R³)SiO_{1/2}
D¹ is (R⁴)(R⁵)SiO_{2/2}
D² is (R⁶)(R⁷)SiO_{2/2}
D³ is (R⁸)(R⁹)SiO_{2/2}
T¹ is (R¹⁰)SiO_{3/2}
Q is SiO_{4/2}
R¹, R², R³, R⁴, R⁵, R⁶, and R⁸ are independently selected from a C1-C200 hydrocarbon, which optionally may have a heteroatom substituted for one or more of the hydrogen atoms;
R⁷ is a group —R¹¹—O—C(O)—C(R¹²)═CH₂, where R¹¹ is a C2-C100 hydrocarbon optionally substituted with one or more heteroatoms, and R¹² is H or a C1-C10 hydrocarbon;
R⁹ is a polyoxyalkyelene group —R¹³—O—(C₂H₄O)_{g}(C₃H₆O)ₕ(C₄H₈O)ᵢ—R¹⁴ where R¹³ is a C1-C50 hydrocarbon, and R¹⁴ is H or a C1-C10 hydrocarbon;
R¹⁰ is selected from hydrocarbon having 1 to 200 carbon atoms, which optionally may have a heteroatom substituted for one or more of the hydrogen atoms; R⁷; or R⁹;
a, b, c, and d are individually positive integers of from 1 to about 100;
e is 0 to about 100, with the proviso that when R¹⁰ is R⁷, e is 1 and c is 0;
f is 0 to about 100;
g is 1 to about 100; and
h and i are individually 0 to about 100.

In one embodiment, R¹, R², R³, R⁴, R⁵, R⁶, and R⁸ are independently selected form a C1-C30 alkyl, a C6-C30 aryl, or a C7-C30 aralkyl.

In one embodiment, R¹, R², R³, R⁴, R⁵, R⁶, and R⁸ are each independently selected from a C1-C10 alkyl.

In one embodiment in accordance with any previous embodiment, R¹¹ has a structure —R¹⁵—R¹⁶—, where R¹⁵ is a divalent C2-C20 alkyl, and R¹⁶ is a divalent C5-C20 cyclic alkyl group.

In one embodiment, R¹⁶ is a hydroxy functional divalent cyclohexyl group.

In one embodiment in accordance with any previous embodiment, R¹¹ is selected from a C2-C20 alkyl.

In one embodiment in accordance with any previous embodiment, R¹² is H or methyl.

In one embodiment in accordance with any previous embodiment, h and i are each 0.

In one embodiment in accordance with any previous embodiment, R¹⁴ is methyl.

In one embodiment in accordance with any previous embodiment, c is 1-100.

In one embodiment in accordance with any previous embodiment, c is 1-10.

In one embodiment in accordance with any previous embodiment, c is 1-2.

In one embodiment in accordance with any previous embodiment, the ratio of d*g to c is 1:1 or greater.

In one embodiment in accordance with any previous embodiment, the ratio of d*g to c is from 1:1 to 100:1.

In one embodiment in accordance with any previous embodiment, a is 2; b is 1-100; c is 1; d is 1-100; and e and fare 0

In one embodiment in accordance with any previous embodiment, D¹_{b} is selected from D^{1′}_{b′} and D^{1″}_{b″} where D^{1′}_{b′} is selected from (R^{4′})(R^{5′})SiO_{2/2} where R^{4′} and R^{5′} are a C1-C3 alkyl, and D^{1″}_{b″} is selected from (R^{4″})(R^{5″})SiO_{2/2} where R^{4″} is a C1-C3 alkyl, and R^{5″} is a C4-C20 alkyl, b′ is 1-100 and b″ is 1-100.

In one embodiment in accordance with any previous embodiment, R^{4′} and R^{5′} are a C1-C3 alkyl, R^{4″} is a C1-C3 alkyl, and R^{5″} is a C4-C10 alkyl, b′ is 1-20 and b″ is 1-20.

In one embodiment, R^{4′}, R^{5′}, and R^{4″} are each methyl, R^{5″} is a C4-C10 alkyl, b′ is 1-20 and b″ is 1-20.

In one embodiment in accordance with any previous embodiment, the organo-functional silicone is water dispersible.

In another aspect, provide is a composition comprising: (a) one or more organo-functional silicone of any of the previous aspects or embodiments; and (b) optionally one or more free-radical polymerizable organic monomers; and (c) water.

In one embodiment, the one or more free-radical polymerizable monomers (b).

In still another aspect, provided is a latex copolymer formed from the composition of any of the previous aspects or embodiments.

In one embodiment, the latex has an average particle size of from about 1 nm to about 10 microns.

In one embodiment in accordance with any previous embodiment, the ratio of (a) to (b) is 99.9 to 0.1 to about 1 to 99.

In one embodiment in accordance with any previous embodiment, the latex has an elongation of 300% or greater measured according to ASTM D6083.

In one embodiment in accordance with any previous embodiment, the latex has an elongation of from 300% to about 1000% measured according to ASTM D6083.

In yet another aspect, provided is a method of forming a latex by the emulsion polymerization of (a) an organo-functional silicone monomer of any of the previous aspects or embodiments, and (b) optionally one or more free-radical polymerizable organic monomers.

In one embodiment, the polymerization is catalyzed by an initiator.

In still yet another aspect, provided is a coating, adhesive, or sealant composition comprising the latex of any of the previous aspects or embodiments.

In one embodiment, the coating composition comprises one or more of a filler, a pigment, a wetting agent, a dispersing agent, a rheology modifier, an anti-cratering agent, a biocides, a coalescent, a cosolvent, a curing agent, a silane, a silicone/siloxane, a defoamers, a fungicide, a heat stabilizer, a leveling agent, a light stabilizer, a mildeweide, an optical brightener, a preservative, a surfactant, an ultraviolet light absorber, a wax, a non-silicone binder, or a mixture of two or more thereof.

In one embodiment in accordance with any previous embodiment, the coating composition has a pigment volume concentration of from about 0 to about 60%

In one embodiment in accordance with any previous embodiment, the coating composition has a pigment volume concentration of from about 20% to about 40%.

In one embodiment in accordance with any previous embodiment, the coating composition has an elongation of 50% or greater as measured by ASTM D 6083.

In one embodiment in accordance with any previous embodiment, the coating composition has an elongation of 50% to about 1000% as measured by ASTM D 6083.

In one embodiment in accordance with any previous embodiment, the coating composition has an elongation of 50% to about 300% as measured by ASTM D 6083.

The following description discloses various illustrative aspects. Some improvements and novel aspects may be expressly identified, while others may be apparent from the description.

### DETAILED DESCRIPTION

Reference will now be made to exemplary embodiments. It is to be understood that other embodiments may be utilized, and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

It will be appreciated that any numerical range recited herein includes all sub-ranges within that range. Additionally, any numerical values including, but not limited to, endpoints of any ranges may be used to form new and non-specified ranges.

Any compound, material, or substance that is expressly or implicitly disclosed in the specification and/or recited in a claim as belonging to a group of structurally, compositionally, and/or functionally related compounds, materials, or substances includes individual representatives of the group and all combinations thereof.

The term “hydrocarbon radical” means any hydrocarbon from which one or more hydrogen atoms has been removed and is inclusive of alkyl, alkenyl, alkynyl, cyclic alkyl, cyclic alkenyl, cyclic alkynyl, aryl, aralkyl and arenyl and may contain heteroatoms.

The term “alkyl” means any monovalent, saturated straight, branched, or cyclic hydrocarbon group; the term “alkenyl” means any monovalent straight, branched, or cyclic hydrocarbon group containing one or more carbon-carbon double bonds where the site of attachment of the group can be either at a carbon-carbon double bond or elsewhere therein; and, the term “alkynyl” means any monovalent straight, branched, or cyclic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkyls include, but are not limited to, methyl, ethyl, propyl and isobutyl. Examples of alkenyls include, but are not limited to, vinyl, propenyl, allyl, methallyl, ethylidenyl norbornane, ethylidene norbornyl, ethylidenyl norbornene and ethylidene norbornenyl. Examples of alkynyls include, but are not limited to, acetylenyl, propargyl and methylacetylenyl.

The terms “cyclic alkyl,” “cyclic alkenyl,” and “cyclic alkynyl” include bicyclic, tricyclic, and higher cyclic structures as well as the aforementioned cyclic structures further substituted with alkyl, alkenyl, and/or alkynyl groups. Examples include, but are not limited to, norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

The term “aryl” means any monovalent aromatic hydrocarbon group; the term “aralkyl” means any alkyl group (as defined herein) in which one or more hydrogen atoms have been substituted by the same number of like and/or different aryl (as defined herein) groups; and, the term “alkaryl” means any aryl group (as defined herein) in which one or more hydrogen atoms have been substituted by the same number of like and/or different alkyl groups (as defined herein). Examples of aryls include, but are not limited to, phenyl and naphthalenyl. Examples of aralkyls include, but are not limited to, benzyl and phenethyl. Examples of alkaryl include, but are not limited to, tolyl and xylyl.

The term “heteroatom” means any of the Group 13-17 elements except carbon. Examples of heteroatoms include, but are not limited to, oxygen, nitrogen, silicon, sulfur, phosphorus, fluorine, chlorine, bromine and iodine.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C1-C2 substituted acrylic acids, such as methacrylic acid, ethacrylic acid, etc., and their C1-C4 alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer.

Provided is an organic-modified silicone, compositions and copolymers thereof. The organic-modified silicone, which may also be referred to herein as an organo-functional silicone, comprises a pendant acrylate functional group and may also be referred to herein as an organo-functional silicone. The organo-functional silicone is polymerizable with organic polymerizable monomers to form a (co)polymer material. The organo-functional silicone can be polymerized in a solvent with an organic polymerizable monomer to form an emulsion. The present organo-functional silicones have been found to be water dispersible and particularly suitable for incorporation in the emulsion polymerization process. Additionally, the use of the present organo-functional silicones provides improvement in one or more mechanical properties of a latex compared to conventional acrylic latex materials.

The organo-functional silicone is a siloxane-based material comprising one or more pendant acrylate functional groups and pendant polyether functional groups. In the present organo-functional silicones, the acrylate functional groups are not attached or connected to the polyether groups. Rather, the acrylate groups and the polyether groups are separate groups generally associated with or connected to separate silicone atoms.

In one embodiment, the organo-functional silicone is a compound of the formula (I):

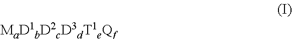

where:
M is R¹(R²)R³)SiO_{1/2}
D¹ is (R⁴)(R⁵)SiO_{2/2}
D² is (R⁶)(R⁷)SiO_{2/2}
D³ is (R⁸)(R⁹)SiO_{2/2}
T¹ is (R¹⁰)SiO_{3/2}
Q is SiO_{4/2}
R¹, R², R³, R⁴, R⁵, R⁶, and R⁸ are independently selected from a C1-C200 hydrocarbon, which optionally may have a heteroatom substituted for one or more of the hydrogen atoms;
R⁷ is a group —R¹¹—O—C(O)—C(R¹²)═CH₂, where R¹¹ is a C2-C100 hydrocarbon optionally substituted with one or more heteroatoms, and R¹² is H or a C1-C10 hydrocarbon;
R⁹ is a polyoxyalkyelene group —R¹³—O—(C₂H₄O)_{g}(C₃H₆O)ₕ(C₄H₈O)ᵢ—R¹⁴ where R¹³ is a C1-C50 hydrocarbon, and R¹⁴ is H or a C1-C10 hydrocarbon;
R¹⁰ is selected from hydrocarbon having 1 to 200 carbon atoms, which optionally may have a heteroatom substituted for one or more of the hydrogen atoms; R⁷; or R⁹;
a, b, c, and d are individually positive integers of from 1 to about 100;
e is 0 to about 100, with the proviso that when R¹⁰ is R⁷, e is 1 and c is 0;
f is 0 to about 100;
g is 1 to about 100; and
h and i are individually 0 to about 100.

In one embodiment, R¹, R², R³, R⁴, R⁵, R⁶, and R⁸ are independently selected form a C1-C30 alkyl, a C6-C30 aryl, or a C7-C30 aralkyl; a C2-C20 alkyl, a C8-C20 aryl, or a C8-C25 aralkyl; or a C4-C10 alkyl, a C10-C18 aryl, or a C10-C20 aralkyl. In embodiments, R¹, R², R³, R⁴, R⁵, R⁶, and R⁸ are independently selected from methyl, ethyl, n-propyl, isopropyl, n-butyl, isobutyl, tert-butyl, n-pentyl, isopentyl, neopentyl and tert-pentyl; hexyl such as n-hexyl; heptyl such as n-heptyl; octyl such as n-octyl, isooctyl and 2,2,4-trimethylpentyl; nonyl such as n-nonyl; decyl such as n-decyl; and cycloalkyl, such as cyclopentyl, cyclohexyl, cycloheptyl and methylcyclohexyl; phenyl; naphthyl; o-tolyl; m-tolyl; p-tolyl; xylyl; ethylphenyl; benzyl, and the like.

In embodiments, R¹, R², R³, R⁴, R⁵, R⁶, and R⁸ are each independently selected from a C1-C10 alkyl, a C2-C8 alkyl, or a C4-C6 alkyl. In embodiments, R¹, R², R³, R⁴, R⁵, R⁶, and R⁸ are each selected from methyl.

In embodiments, b is 1-100, 2-95, 3-90, 4-85, 5-80, 10-75, 15-70, 20-65, 25-60, 30-55, 35-50, or 40-45.

In embodiments, D¹_{b} is selected from D^{1′}_{b′} and D^{1′}_{b′} where D^{1′}_{b′} is selected from (R^{4′})(R^{5′})SiO_{2/2} where R^{4′} and R^{5′} are a C1-C3 alkyl, and D^{1″}_{b″} is selected from (R^{4″})(R^{5″})SiO_{2/2} where R^{4″} is a C1-C3 alkyl, and R^{5″} are a C4-C20 alkyl, a C6-C18 alkyl, a C8-C15 alkyl, or a C10-C12 alkyl, b′ is 1-100 and b″ is 1-100. In embodiments, b′ is 1-100, 2-95, 3-90, 4-85, 5-80, 10-75, 15-70, 20-65, 25-60, 30-55, 35-50, or 40-45, and b″ is 1-100, 2-95, 3-90, 4-85, 5-80, 10-75, 15-70, 20-65, 25-60, 30-55, 35-50, or 40-45. In embodiments, b′ is 1-50, 2-40, 3-35, 4-30, 5-25, 6-20, 7-15, 8-14, or 9-12, and b″ is 1-50, 2-40, 3-35, 4-30, 5-25, 6-20, 7-15, 8-14, or 9-12. In one embodiment, R^{4′} and R^{5′} are a C1-C3 alkyl, R^{4″} is a C1-C3 alkyl, and R^{5″} is a C4-C10 alkyl, a C6-C9 alkyl, or a C7-C8 alkyl. In one embodiment, R^{4′}, R^{5′}, and R^{4″} are each methyl, and R^{5″} is octyl. An example of a monomer falling under one or more of such embodiments includes, for example, monomer (II-i) shown herein.

The organo-functional silicone comprises an acrylate functional group. In one embodiment, the acrylate functional group is linked to the siloxane backbone via a linker group comprising a hydroxyl group. In one embodiment, the linker group comprises a hydroxyl functional cycloaliphatic group. In embodiments, the acrylate functional group is selected from a group R⁷ of the formula —R¹¹—O—C(O)—C(R¹²)═CH₂, where R¹¹ is a C2-C100 hydrocarbon optionally substituted with one or more heteroatoms, and R¹² is H or a C1-C10 hydrocarbon. In embodiments, R¹¹ is selected from a C2-C20 alkyl a C4-C15 alkyl, a C6-C12 alkyl, or a C8-C10 alkyl. As previously described, an alkyl group may include a cyclic alkyl group pendant to or within the chain of a main alkyl group.

In one embodiment, R¹¹ has a structure —R¹⁵—R¹⁶—, where R¹⁵ is a divalent C2-C20 alkyl, a divalent C4-C15 alkyl, a divalent C6-C12 alkyl, or a divalent C8-C10 alkyl, and R¹⁶ is a hydroxyl functional divalent C5-C20 cyclic alkyl group, a hydroxy functional divalent C6-C18 cyclic alkyl group, or a C8-C12 cyclic alkyl group.

In one embodiment, c is 1-100, 1-10, or 1-2. In one embodiment, c is 1.

The organo-functional silicone also comprises siloxane units having a pendant polyether. The polyether can be of the formula —R¹³—O—(C₂H₄O)_{g}(C₃H₆O)ₕ(C₄H₈O)ᵢ—R¹⁴ where R¹³ is a C1-C50 hydrocarbon, and R¹⁴ is H or a C1-C10 hydrocarbon, where g is 1 to about 100; and h and i are individually 0 to about 100. In one embodiment, h and i are each 0, and g is 1 to 100, 2 to 90, 5 to 80, 7 to 70, 10 to 50 or 20 to 40.

In the organo-functional silicone, the ratio of polyethelene glycol units to acrylate containing units) is 1:1 or greater. In one embodiment, the ratio of g to c is from 1:1 to 200:1, 1:1 to 150:1, 1:1 to 100:1, from 2:1 to 90:1, from 3:1 to 80:1, from 4:1 to 70:1, from 5:1 to 60:1, from 10:1 to 50:1, from 15:1 to 40:1, or from 20:1 to 30:1. The ratio of polyethylene glycol units may be represented by (d*g):c where g is the number of oxyethylene groups in polyethylene glycol units and d is the number of D³ units in the compound of formula (I), and c is the number of D² units.

In embodiments, the organo-functional silicone is provided such that a is 2; b is 1-100, 2-80, 5-75, 10-60, 15-50, 20-40, or 25-30; cis 1; dis 1-100, 2-80, 5-75, 10-60, 15-50, 20-40, or 25-30; and e and fare 0.

In one embodiment, the organo-functional silicone is provided such that a is 2, D¹_{b} is selected from D^{1′}_{b′} and D^{1″}_{b″} where D^{1′}_{b′} is selected from (R^{4′})(R^{5′})SiO_{2/2} where R^{4′} and R^{5′} are a C1-C3 alkyl, and D^{1″}_{b″} is selected from (R^{4″})(R^{5″})SiO_{2/2} where R^{4″} is a C1-C3 alkyl, and R^{5″} are a C4-C20 alkyl, a C6-C18 alkyl, a C8-C15 alkyl, or a C10-C12 alkyl, b′ is 1-100, 2-80, 5-75, 10-60, 15-50, 20-40, or 25-30, b″ is 1-100, 2-80, 5-75, 10-60, 15-50, 20-40, or 25-30, c is 1; d is 1-100, 2-80, 5-75, 10-60, 15-50, 20-40, or 25-30; and e and fare 0.

In one embodiment, the organo-functional silicone is of the formula (II):

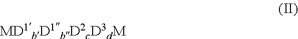

where M, D^{1′}, D^{1″}, D², D³, b′, b″, c, and d are as described above. In one embodiment, c is 1.

In one embodiment, the organo-functional silicone is of the formula (I-i):

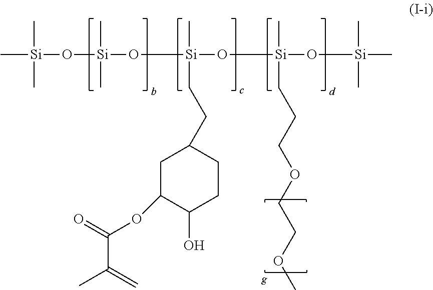

where b, c, and d are as described above. In one embodiment, b is 5-50, 10-40, or 20-30; c is 1; d is 1-20, 2-18, 3-15, 4-12, or 5-10; and g is 1-50, 2-40, 5-30, 7-25, or 10-20.

In one embodiment, the organo-functional silicone is of the formula (II-i):

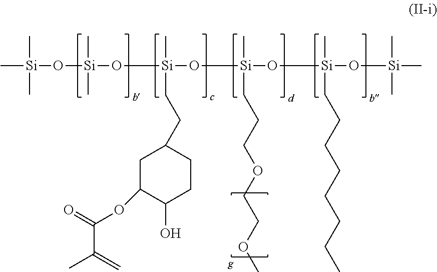

where b′, b″, c, and dare as described above. In one embodiment, b′ is 5-50, 10-40, or 20-30; c is 1; d is 1-20, 2-18, 3-15, 4-12, or 5-10; b″ is 1-20, 2-15, 3-10, or 4-8; and g is 1-50, 2-40, 5-30, 7-25, or 10-20.

It will be appreciated that the organo-functional silicone may be a random or block co-polymer of the various M, D, T, or Q units.

It will be appreciated that the organo-functional silicone may be formed by the reaction of a hydride functional polysiloxane with an alkenyl functional compound of the desired functionalities, e.g., acrylate, polyalkyelene oxide, and the like.

The present technology also provides a latex composition comprising an organosiloxane monomer, i.e., an organo-functional silicone as described herein, and optionally a free-radical polymerizable monomer, where the free-radical polymerizable monomer is copolymerizable with organosiloxane monomer. The latex composition may comprise just the organo-functional silicone, which may react to form a homopolymers. In embodiments, the latex comprises a free-radical polymerizable monomer in addition to the organo-functional silicone. The free-radical polymerizable monomer is generally free-radical copolymerizable with the acrylate group of the organosiloxane monomer. In embodiments, to form a latex, the organo-functional silicone is of the Formula I and provided such that c is 1, i.e., the compound is a mono-acrylate-functional silicone.

The free-radical polymerizable monomer may be selected from an organic monomer and may also be referred to herein as a free-radical polymerizable organic monomer. The free-radical polymerizable monomer may be selected as desired for a particular purpose or intended application. In embodiments, the free-radical polymerizable monomer is selected from an acrylate monomer, an ehtylenically unsaturated monomer, or mixtures thereof.

Examples of suitable acrylate monomers for the free-radical polymerizable monomer include, but are not limited to, acrylic acid, methacrylic acid, their esters and their amide derivatives such as methylacrylate, bultylacrylate, propylacrylate, N,N-dimethylacrylamide, N-isopropyl acrylamide, 2-ethylhexyl acrylate, cyclohexyl acrylate, vinlylacrylate, allylacrylate, hydroxyethyl acrylate, perfluoroethyl acrylate, isobornyl acrylate, lauryl arylate, phenoxyethyl acrylate, tetraethylene glycol diacrylate, tripropylene glycol diacrylate, acrylamide, methacrylamide, acrylated silane, methacrylated silane, methacryloxyl silane, 2-hydroxyethylmethacrylate, 3-[tris(trimethylsiloxy)silyl]propyl methacrylate, acrylate and methacrylate functional carbosilanes, hexafunctional urethane acrylates, dipentaerythritol pentaacrylate, ethoxylated pentaerythritol tetraacrylate, di-trimethylolpropane tetraacrylate, pentaerythritol triacrylate, trimethylolpropane triacrylate, ethoxylated trimethylolpropane triacrylate, butanediol diacrylate, tripropylene glycol diacrylate, trimethylolpropane trimethacrylate, oligofunctional urethane acrylates, tetraacrylate monomer, polyester acrylate oligomers, and combinations thereof.

Examples of suitable ethylenically unsaturated monomers suitable for use the free-radical polymerizable monomer include, but are not limited to, butadiene, styrene, ethyl styrene, divinyl benzene, N-vinyl pyrrolidone, N-vinyl lactam, vinyl halides, vinyl acetates, vinyl alcohols, vinyl ethers, allyl alcohols, allyl polyethers and others that can react with the polymerizable group of the organo-functional silicone. Suitable vinyl monomers include vinyl esters, vinyl aromatic hydrocarbons, vinyl aliphatic hydrocarbons, vinyl alkyl ethers, or a mixture of two or more thereof. Examples of vinyl esters that may be used include, but are not limited to, vinyl acetate, vinyl propionate, vinyl laurate, vinyl pivalate, vinyl nonanoate, vinyl decanoate, vinyl neodecanoate, vinyl butyrates, vinyl benzoates, vinyl isopropyl acetates, or a combination or two or more thereof. Examples of vinyl aromatic hydrocarbons that may be used include, but are not limited to, styrene, methyl styrenes and other lower alkyl styrenes, chlorostyrene, vinyl toluene, vinyl naphthalene, divinyl benzene, or a combination of two or more thereof. Examples of vinyl aliphatic hydrocarbons that may be used include, but are not limited to, vinyl chloride and vinylidene chloride as well as alpha olefins such as ethylene, propylene, isobutylene, hexylene and octylene, as well as conjugated dienes such as, but not limited to, 1,3 butadiene, methyl-2-butadiene, 1,3-piperylene, 2,3-dimethyl butadiene, isoprene, cyclohexadiene, cyclopentadiene and dicyclopentadiene. Examples of vinyl alkyl ethers that may be used include, but are not limited to, methyl vinyl ether, isopropyl vinyl ether, n-butyl vinyl ether and isobutyl vinyl ether.

The weight ratio of total organo-functional silicone (monomer) to the free-radical polymerizable organic monomer is from about 99.9 to 0.1, 99 to 1, 95 to 5, 90 to 10, 80 to 20, 60 to 40, 50 to 50, 40 to 60, 20 to 80, 90 to 10, or 1 to 99. In embodiments the weight ratio of total organic-functional silicone monomer to the free-radical polymerizable organic monomer is from about 99.9:1 to about 1:99, from about 95:5 to about 5:95, from about 90:10 to about 10:90, from about 80:20 to about 20:80, from about 75:25 to about 25:75; from about 70:30 to about 30:70, from about 60:40 to about 40:60, or about 50:50.

The organo-functional silicone and the free-radical polymerizable organic monomer are reacted to form a latex. The latex may comprise particles having an average particle size of from about 1 nm to about 10 microns, from about 5 nm to about 800 nm, from about 20 nm to about 700 nm, from about 50 nm to about 500 nm, from about 75 nm to about 400 nm, from about 100 nm to about 300 nm, or from about 150 nm to about 250 nm. Particle size can be determined by any suitable method such as dynamic light scattering. In embodiments, particle size is evaluated using a Malvern Zetasizer Nano ZS instrument.

A latex may be provided by reacting to the organo-functional silicone monomer in the presence of a surfactant and emulsifying the composition. In embodiments, a latex may be provided by reacting the organo-functional silicone monomer with a free-radical polymerizable organic monomer in the presence of a surfactant and emulsifying the composition. This may also be carried out in the presence of a catalyst or initiator and heating the composition.

In one embodiment, an emulsion of desired particle size can be prepared by dispersing an organo-functional silicone of Formula I and a free-radical polymerizable monomer with a surfactant to form a stable emulsion containing 10-80% of total monomers. The mixture can be further stabilized by addition of common thickeners, such as xanthan or guar gum, gelatin, cellulose derivatives, and the like. A free-radical catalyst can then be added to the emulsion, and the emulsion can be heated to or above the temperature necessary for initiating the reaction. In embodiments, heating may be conducted at a temperature of from about 20 to about 100° C. the temperature may depend on the catalyst being used. The reaction may be carried out for a period of time as needed for the reaction to be sufficiently completed. In embodiments, the reaction can be conducted for a period of time of from about 1 to about 10 hours or until the unsaturated groups are consumed.

A process for seed emulsion polymerization is disclosed. In embodiments, a process for thermal-initiated seed emulsion polymerization comprises preparing a monomer emulsion by dispersing desired monomers in water with a surfactant under stirring, followed by the introduction of 5-10% of the monomer emulsion into water containing an initiator and surfactant. The reaction mixture is heated to 70-90° C. for 10-15 minutes until a bluish hue is observed, indicating the initiation of polymerization and seed formation. After initiation of polymerization, the remaining monomer emulsion and initiator are added slowly over a period of 4-6 hours while maintaining the temperature at 70-90° C. Upon consumption of 40-50% of the monomer emulsion, a silicone acrylate monomer, which is dispersible in water, is simultaneously added, ensuring that both the monomers and initiator are consumed concurrently. Following the completion of this addition, the reaction is maintained for an additional hour, after which time the temperature is reduced to 40-65° C., and redox initiators are applied to facilitate the complete consumption of unreacted monomers. Finally, ammonium hydroxide is introduced to adjust the pH and other optional additives can be added.

The surfactant(s) can be selected from among the anionic, cationic, zwitterionic, and non-ionic surfactants and their combinations.

Examples of suitable anionic surfactants include, but are not limited to, carboxylates, sulfates, sulfonates, alkylaryl sulfonates alkyl phosphates, and the like. Examples of some types of anionic surfactants include, but are not limited to, dodecylbenzenesulfonic acid, octylbenzenesulfonic acid, polyoxyethylene lauryl sulfate, lauryl sulfate, tetradecenesulfonic acid, hydroxytetradecenesulfonic acid, and sodium salt, potassium salt, triethanolamine salt thereof, and the like.

In embodiments, the anionic surfactant may have a relatively high hydrophilic-lipophilic balance (HLB). In embodiments the anionic surfactant may have a HLB above about 15

Examples of cationic surfactants include, but are not limited to, lauryltrimethylanunonium hydroxide, stearyltrimethylammonium. hydroxide, dioctyldimethylammonium hydroxide, distearyldimethylammonium hydroxide, lauryltrimethylammonium chloride, stearyltrimethylammonium chloride, cetyltrimethylammonium chloride, dicocyldimethylammonium chloride, distearyldimethylammonium chloride, benzalkonium chloride, stearyldimethylbenzylammonium chloride, and the like. Other suitable cationic surfactants include, but are not limited to, amidoamine derivatives such as behenamidopropyl dimethylamine or esterquat based on long alkyl chain, for example behenoyl PG-trimonium chloride.

Examples of suitable nonionic surfactants include, but are not limited to, polyoxyethylene lauryl ether, polyoxyethylene fatty acid ester, polyoxyethylene sorbitan fatty acid ester, sorbitan fatty acid ester, glycerine fatty acid ester, polyoxyethylene hardened castor oil, polyoxyethylene sorbitol fatty acid ester, and the like. Other suitable nonionic include, for example, alkylpolyglucosides.

In one embodiment, the surfactants can be, for example, the alkali metal salts of long chain alkyl sulfates and sulfonates such as dodecyl-1 acid sulfate, tetradecyl-1 acid sulfate, octadecyl-1 acid sulfate, dodecane-1-sulfonic acid, tetradecane-1-sulfonic acid, hexadecane-sulfonic acid and octadecane-sulfonic acid, and salts of long chain sulfonated paraffinic hydrocarbons and their combinations.

The catalyst/initiator(s) can be selected as desired for the reaction of the polymerizable monomers. Examples of suitable, but are not limited to, hydrogen peroxide, ammonium persulfate, potassium persulfate, sodium persulfate, the organic peroxides, azo compounds, and combinations thereof. Some examples of organic peroxide catalysts include, but are not limited to, dialkyl peroxides, e.g., diisopropyl peroxide, dilauryl peroxide, di-t-butyl peroxide, dicumyl peroxide, alkyl hydrogen peroxides such as t-butyl hydrogen peroxide, t-amyl hydrogen peroxide, cumyl hydrogen peroxide, diacyl peroxides, for instance acetyl peroxide, lauroyl peroxide, benzoyl peroxide, peroxy ester such as ethyl peroxybenzoate, the azo compounds such as 2-azobis(isobutyronitrile), and the like.

The initiator(s) may also be selected from co-initiators such as Fe, Cr²⁺, V²⁺, Ti3+, Co²⁺, Cu⁺ and the like. The initiator is added to the emulsion to commence the copolymerization of the free-radical polymerizable monomers. Depending on the nature of the selected initiator, copolymerization temperatures of from 5° to 100° C. with reaction times of from 1 to 10 hours are generally suitable.

A latex formed from the composition may have an elongation of 300% or greater. In embodiments, the latex has an elongation of from 300% to about 1000%, from about 350% to about 950%, from about 375% to about 925%, from about 400% to about 900%, from about 425% to about 875%, from about 450% to about 850%, from about 475% to about 825%, from about 500% to about 800%, from about 525% to about 775%, from about 550% to about 750%, from about 575% to about 725%, from about 600% to about 700%, or from about 625% to about 675%. Elongation may be measured according to ASTM D6083.

The present compositions and latex materials formed therefrom may contain one or more optional components as may be employed or utilized for particular applications. The present compositions may be employed as coatings (e.g., may be used in paint formulations), adhesives, sealant, in personal care products, and others.

In embodiments, the latex formed from the compositions may be employed in personal care products, and the composition may include any ingredients now known or later discovered for personal care products employed in the customary amounts. Among these ingredients include, but are not limited to, a silicone, surfactant, emulsifier, solvent such as linear and cyclic siloxane, organic estes, alkane such as isododecane, isohexadencane, emollient, moisturizer, humectant, pigment, colorant, fragrance, preservative, antioxidant, biocide, biostat, antiperspirant, exfoliant, hormone, enzyme, medicinal, vitamin substance, hydroxy acid, retinal, retinol derivative, niacinamide, skin lightening agent, salt, electrolyte, alcohol, polyol, ester, scattering and/or absorbing agent for ultraviolet radiation, botanical extract, peptide, protein, organic oil, gum, saccharide, oligosaccharide, polysaccharide, derivative, wax, film former, thickening agent, particulate filler, plasticizer, humectant, occlusive, sensory enhancer, resin, optically active particle, and the like. These compounds may be added before, during, or after polymerization of the monomers.

In embodiments, the latex formed from the compositions is employed as a coating or as part of a coating composition. In embodiments, the latex may be provided as film-forming material of the coating composition. Coating compositions may include, for example colorants, fillers, wetting agents, dispersing agents, defoamer, thickeners, and the like.

As used herein, the term “colorant” means any substance that imparts color and/or other opacity and/or other visual effect to the polymer. The colorant can be added to the emulsion composition in any suitable form such as discrete particles, dispersions, solutions, flakes, etc. A single colorant or a mixture of two or more colorants can be used in the oil-in-water emulsion composition of the invention.

Useful colorants include pigments, dyes, and tints such as those used in the paint industry and/or listed in the Dry Color Manufacturers Association (DCMA), as well as special-effect materials. A useful type of colorant can be a finely divided solid powder that is insoluble but wettable under the conditions of use. A colorant can be organic or inorganic and can be agglomerated or non-agglomerated. Colorants can be incorporated into the oil-in-water emulsion composition by use of a grinding vehicle such as an acrylic grinding vehicle the use of which is familiar to those skilled in the art.

Illustrative useful pigments and pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Useful dyes include, but are not limited to, those that are solvent and/or aqueous based such as phthalo green or blue, iron oxide, bismuth vanadate, anthraquinone, perylene, aluminum and quinacridone.

Useful tints include, but are not limited to, pigments dispersed in water-based or water miscible carriers such as AQUA-CHEM® 896 commercially available from Degussa, Inc., CHARISMA COLORANTS® and MAXITONER INDUSTRIAL COLORANTS® commercially available from Accurate Dispersions division of Eastman Chemical, Inc. In general, the colorant can be present in the emulsion composition in any amount that is sufficient to impart the desired visual and/or color effect. The colorant can comprise from, for example, 1 to 65 weight percent of the oil-in-water emulsion composition, such as from 3 to 40 weight percent or 5 to 35 weight percent thereof based on the total weight of the oil-in-water emulsion composition.

A coating composition comprising a latex in accordance with the present technology may have a pigment volume concentration (PVC) of from 0 to about 60, from about 1 to about 55, from about 2 to about 50, from about 5 to about 45, from about 10 to about 40, from about 15 to about 35, or from about 20 to about 30. The term “pigment volume concentration” refers to the total percentage of the dried solids occupied by a recited pigment species or, if no specific pigment species is referred to, it refers to the percentage of dried solids occupied by all pigment species in the composition.

The emulsion composition can include a filler. The filler can be any inorganic or organic filler that reinforces and/or extends the oil-in-water emulsion composition. Useful fillers include, for example, reinforcing fillers such as carbon black, fumed silica, precipitated silica, clays, talc, aluminum silicates, metal oxides and hydroxides, and extending fillers such as treated and untreated calcium carbonates, and the like. Fillers can be in the form of powders, particulates, aggregates, agglomerates, platelets, fibers, etc. In one embodiment, one or more fillers are combined with silane coupling agents.

The filler may also include, for example, extender particles or extender pigments. The terms “extender particle” and “extender pigment” refer to a particulate solid material that does not materially affect tint but can be included in a paint or other coating composition to reduce the amount of colored pigment required to attain a desired tint or color strength, or for affecting other properties such as oil absorption, flatness, opacity, film strength, film hardness, corrosion resistance, film permeability or coating composition viscosity. Examples of extender particles include, but are not limited to, calcium carbonate, calcium sulfate, barium sulfate, mica, clay, calcined clay, feldspar, nepheline, syenite, wollastonite, diatomaceous earth, alumina silicates, non-film forming polymer particles, aluminum oxide, silica, talc, mixtures thereof and other materials that will be familiar to persons having ordinary skill in the art. The chosen extender pigment types and amounts may vary widely and normally will be empirically determined using techniques that will be familiar to persons having ordinary skill in the art. Extender particles may generally be included in calculating the pigment volume concentration.

The optional fillers can be incorporated in the oil-in-water emulsion composition in an amount of up to 80 weight percent, advantageously in an amount of up to 50 weight percent, and in certain embodiments, in an amount of from 20 weight percent to 50 weight percent based on the total weight of the emulsion composition.

As mentioned, the coating composition may include any other materials as may be suitable for a coating, paint, adhesive, or the like. The coating composition may include wetting agents or dispersing agents. Examples of suitable wetting agents include, but are not limited to, those sold under the tradename CARBOWET® or DYNOL™ from Evonik, CAPSTONE™ from Chemours, STEPWET® from Stepan Compane, DISPEX® from BASF, and the like. Examples of dispersing agents include, but are not limited to, those sold under the tradename SURFYNOL® from Evonik, ULTRALEC® from Archer Daniels Midland Co., DISPEX® form BASF, and the like.

The coating composition may include adjuvants such as, but not limited to, anti-cratering agents, biocides, coalescents, cosolvents, curing indicators, defoamers, fungicides, heat stabilizers, leveling agents, light stabilizers, mildewcides, optical brighteners, preservatives, surfactants, ultraviolet light absorbers, waxes and the like. The types and amounts of these and other coating composition adjuvants typically will be empirically selected. Such materials are common to the coating industry and the types and amounts of such materials may be readily selected by those skilled in the art for a particular purpose or intended application.

A coating composition comprising a latex or binder formed from the organo-functional silicone monomers in accordance with the present technology may optionally comprise a non-silicone latex (as a co-binder or co-film forming material) Examples of suitable organic monomers include, but are not limited to, acrylic copolymers, styrene/acrylic copolymers, vinyl acetate copolymers, vinyl acetate/acrylic copolymers, vinyl versatic acid ester/acrylic copolymers, ethylene/vinyl acetate copolymers, styrene/butadiene copolymers, polyesters, alkyd paints, drying oil modified polymers such as polyesters and polyurethanes, polyamides, epoxy esters, polyureas, polyurethane dispersions, fluorinated copolymers such as vinylidene fluoride, and blends of any of the above polymeric binders. The binder may include a component or components of a multicomponent (e.g., two component) reactive system such as a component of an isocyanate-polyamine, isocyanate-polyol, isocyanate-amine, epoxy-polyamine, carbodiimide-polyacid, aziridine-polyacid, melamine-polyol, or urea formaldehyde-polyol coating system.

In embodiments, the coating comprises an organic monomer selected from alkyl acrylate, alkyl alkacrylate, alkylacrylic acid material.

In a composition comprising a co-binder/latex component, the composition may have a ratio of organo-functional silicone monomer to organic monomer of from about 50:1 to 1:50; about 40:1 to about 1:40, about 30:1 to about 1:30, about 25:1 to about 1:25, about 20:1 to about 1:20, about 15:1 to about 1:15, about 10:1 to about 1:10, about 5:1 to about 1:5, about 3:1 to about 1:3, about 2:1 to about 1:2, about 1.5:1 to about 1:1.5, or about 1:1.

A coating composition comprising the latex may have an elongation of from about 50% to about 1000%; from about 60% to about 975%; from about 70% to about 950%; from about 80% to about 925%; from about 90% to about 900%; from about 100% to about 875%; from about 110% to about 850%; from about 120% to about 825%; from about 130% to about 800%; from about 140% to about 775%; from about 150% to about 750%; from about 160% to about 725%; from about 170% to about 700%; from about 180% to about 675%; from about 190% to about 650%; from about 200% to about 625%; from about 210% to about 600%; from about 220% to about 575%; from about 230% to about 550%; from about 240% to about 525%; from about 250% to about 500%; from about 260% to about 475%; from about 270% to about 450%; from about 280% to about 425%; from about 290% to about 400%; from about 300% to about 375%; from about 310% to about 350%; from about 320% to about 325%. Elongation may be measured using ASTM D 6083.

The hydrobic hybrid organosiloxane nano latex herein can improve the wear resistance and sensory properties of a broad range of personal care products, for example, deodorants, antiperspirants, antiperspirant/deodorants, stick and roll-on products, skin lotions, moisturizers, toners, cleansing products, styling gels, hair dyes, hair color products, hair straighteners, nail polish, nail polish remover, sunscreens, anti-aging products, lipsticks, lip balms, lip glosses, foundations, face powders, eye liners, eye shadows, blushes, makeup, beauty balms, mascaras, moisturizing preparations, foundations, concealers, body and hand preparations, skin care preparations, face and neck preparations, fragrance preparations, soft focus applications, night and day skin care preparations, tanning preparations, hand liquids, non-woven applications for personal care, baby lotions, facial cleansing products, hair cuticle coats, gels, foam baths, body washes, scrubbing cleansers, controlled-release personal care products, hair shampoos, hair conditioners, hair sprays, skin care moisturizing mists, skin wipes, pore skin wipes, pore cleaners, blemish reducers, skin exfoliators, skin desquamation enhancers, skin towelettes and cloths, depilatory preparations, personal care lubricants, nail coloring preparations and drug delivery systems for topical application of medicinal compositions that are to be applied to the skin.

### Examples 1-5

### Acrylate-Functional Silicone Monomer

A stoichiometric amount of polydimethylsiloxane having approximately 4 pendant hydride with approximately 15 D-length (PDMSH) and a vinyl cyclohexane methacrylate (VCHMA) were charged into a 1 L round bottom flask (4 necked), equipped with a mechanical stirrer, dropping funnel, nitrogen inlet, and thermometer. The mixture was heated to 40° C., and after reaching 40° C., 10 ppm of chloroplatinic acid (CPA) catalyst was added to the round bottom flask. The reaction mixture was agitated until the vinyl cyclohexane methacrylate is completely consumed. After that, 2000 ppm of butylated hydroxy toluene (BHT) inhibitor was added to the system and the temperature was raised to 60° C. Then, the required amount of allyl polyethylene glycol (30% extra to avoid isomerization issue) was added to the reaction mixture, and the reaction is continued at 60° C. until the complete conversion of the allyl moiety of the allyl polyethylene glycol. After that, the required amount of 1-octene (30% extra to avoid isomerization) was added to the reaction mixture and the reaction continued at 60° C. until the complete disappearance of the hydride peak in 1H-NMR. After 22 hours, the hydride was completely consumed, and at this point reaction was stopped and cooled to room temperature. The material was transferred into an amber colored plastic container. The material was confirmed by 1H NMR characterization.

Synthesis of Hydroxy-vinyl-cyclohexyl Methacrylate (VCHMA):

Methacrylic acid (43 g) and MEHQ (430 mg) were taken in a 250 mL three-neck round bottom flask fitted with a thermometer, a dropping funnel, and condenser. The contents were stirred at 250 rpm for 30 minutes under positive pressure of N₂. Once the entire solid is dissolved, 960 mg of LiOH was added in two portions with a time gap of around 30 mins. The suspension was stirred for an additional one hour at room temperature before the addition of VCHO at a rate of 1 drop/sec. After complete addition, the resulting mixture was slowly heated and stirred at 55° C. After around 44 hours, 1H NMR confirmed complete conversion of the epoxide. The crude reaction mixture was then diluted with EtOAc and washed with saturated NaHCO₃ solution followed by brine solution, and finally dried over anhydrous Na₂SO₄. The volatiles were removed under reduced pressure to yield a light-yellow colored viscous liquid.

The above process was followed to prepare different acrylate-functional silicone monomers based on the concentration of the respective functional groups as set out in table 1.

TABLE 1
Details of organo-functional silicone monomer

| | | | Vinyl | Allyl | |
|---|---|---|---|---|---|
| | | | cyclohexane | polyethylene | 1- |
| | Silicone | PDMSH | methacrylate | glycol | octene |
| Ex. | monomer | (g) | (g) | (g) | (g) |
| 1 | X1 | 250 | 34.23 | 345.26 | 0 |
| 2 | X2 | 250 | 34.23 | 89.75 | 73.07 |
| 3 | X3 | 250 | 34.23 | 179.14 | 47.40 |
| 4 | X4 | 250 | 34.23 | 268.71 | 23.75 |
| 5 | X5 | 200 | 11.30 | 296.5 | 0 |

The monomer X1 may be represented by the formula:

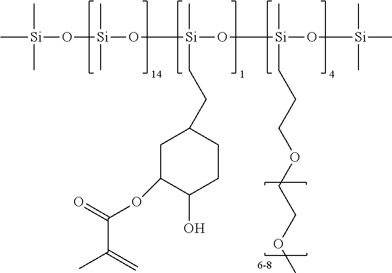

The monomer X2 may be represented by the formula:

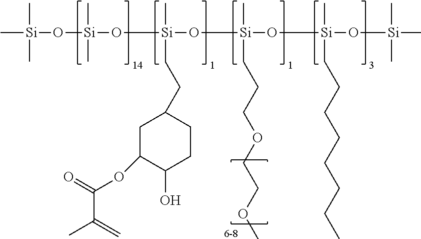

The monomer X5 may be represented by the formula:

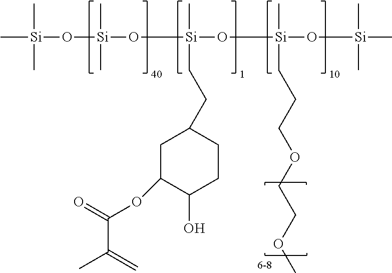

### Synthesis of Latex

Example 6: Monomer emulsion was prepared by mixing 58.5 grams of butyl acrylate, 59.7 grams of methyl methacrylate, and 1.2 grams of methacrylic acid in 40 grams of water and 11.6 gram of Disponil FES 32. To a four neck flask equipped with a thermometer, two pressure equalizers, a positive nitrogen pressure system, and a mechanical stirrer, 39 grams of water, 3.9 grams of 31% SLES, and 0.3 grams of potassium persulfate were charged, and the temperature was raised to 75° C. To this mixture, 10% of monomer emulsion was added under stirring conditions. The reaction was continued at 180 rpm under N₂ atmosphere for 10-15 minutes until the exotherm was over. After raising the temperature to 85° C., 50% of monomer emulsion and 0.2 grams of potassium persulfate in 5 ml water were added simultaneously over 2 hours. After that, 13.2 grams of methacrylate functionalized polydimethylsiloxane (X1) dispersed in 26 grams water, remaining 40% monomer emulsion, and 0.1 gm of potassium persulfate in 5 ml water were added simultaneously over a 1 hour time period. The reaction was continued for another 2 hours, and the temperature was decreased to 65° C. 0.1 gram of tertbutyl peroxide in 5 ml water, and 0.1 gram of sodium formaldehyde sulfoxylate in 5 ml water were added simultaneously drop wise and stirring was continued for another hour. The heating was stopped and after reaching room temperature the reaction mixture was filtered and neutralized by ammonium hydroxide. The particle size was determined by Malvern Zetasizer Nano ZS.

Example 7: A latex was prepared by following the procedure in Example 6, using X2 instead of X1. 13.2 grams of X2 in 26 grams of water containing 0.5 gm Cetyl Alcohol was used.

Example 8 was prepared by following the procedure in Example 7 using silicone acrylate monomer X3.

Example 9 was prepared by following the procedure in Example 7 using silicone acrylate monomer X4.

Example 10 was prepared by following the procedure of Example 6 using silicone acrylate monomer X5.

Example 11 was prepared by following the procedure of Example 6 using silicone acrylate monomer X1, except the monomer emulsion composition in the first step included 65.1 grams of butyl acrylate, 66.3 grams of methyl methacrylate, and 1.2 grams of methacrylic Acid in 50 gm of waterand. Also, 6.6 grams of X1 was dispersed in 36 grams of water for the second stage of feeding.

Example 12: Monomer emulsion for seed was prepared by mixing 4.48 grams of butyl acrylate, 4.58 grams of methyl methacrylate, and 0.12 grams of methacrylic acid in 6.6 grams of water and 1.16 gram of Disponil FES 32. The monomer emulsion of feed was prepared by mixing 40.41 grams of butyl acrylate, 41.23 grams of methyl methacrylate, 39.78 grams of methacrylate functionalized polydimethylsiloxane (X1), and 1.08 grams of methacrylic acid in 59.4 grams of water and 10.44 gram of Disponil FES 32. To a four neck flask equipped with a thermometer, two pressure equalizers, a positive nitrogen pressure system, and a mechanical stirrer, 39 grams of water, 3.9 grams of 31% SLES, and 0.3 grams of potassium persulfate were charged, and the temperature was raised to 75° C. To this mixture, monomer emulsion for seed was added under stirring conditions. The reaction was continued at 180 rpm under N₂ atmosphere for 10-15 minutes until the exotherm was over. After raising the temperature to 85° C., monomer emulsion of feed and 0.3 grams of potassium persulfate in 10 ml water were added simultaneously over 4 hours. The reaction was continued for one hour, and the temperature was decreased to 65° C. 0.1 gram of tertbutyl peroxide in 5 ml water, and 0.1 gram of sodium formaldehyde sulfoxylate in 5 ml water were added simultaneously drop wise and stirring was continued for another hour. The heating was stopped and after reaching room temperature the reaction mixture was filtered and neutralized by ammonium hydroxide. The particle size was determined by Malvern Zetasizer Nano ZS.

Example 13 was prepared by following the procedure of Example 12 using silicone acrylate monomer X1, except that the monomer emulsion composition for feed was 20.71 grams of butyl acrylate, 21.94 grams of methyl methacrylate, 1.08 grams of methacrylic Acid, and 79.56 grams of methacrylate functionalized polydimethylsiloxane (X1) in 59.4 grams of water and 10.44 gram of Disponil FES 32.

Comparative Example 1 was prepared by following the procedure in Example 1, using a terminal functionalized diacrylate polydimethylsiloxane (X6) which can be represented by the formula below.

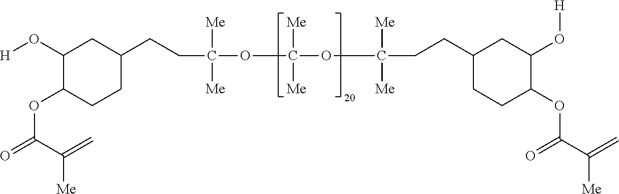

As the monomer was not dispersible in water, an emulsion was made by mixing 13.2 gm of X6 in 26 grams of water, 0.5 grams of cetyl alcohol, and 2.35 grams of Disponil FES 32 before feeding. An excessive amount of grit was formed during the process, which was filtered out before measurements. Comparative Example 2 was prepared following the procedure of Example 1 but without any silicone monomer. Comparative Example 2 employs organic monomers to provide a latex with butyl acrylate, methyl methacrylate, and methacrylate acid in a ratio of 49:50:1.

TABLE 2
Details of latex

| | | Loading of | Water | |
|---|---|---|---|---|
| | | Silicone | dispersibility | Particle |
| | Silicone | monomer | of Si- | size |
| Example | Monomer | (% w/w) | monomer | (nm) |
| 6 | X1 | 10 | Yes | 110 |
| 7 | X2 | 10 | Yes | 92 |
| 8 | X3 | 10 | Yes | 118 |
| 9 | X4 | 10 | Yes | 109 |
| 10 | X5 | 10 | Yes | 109 |
| 11 | X1 | 5 | Yes | 110 |
| 12 | X1 | 30 | Yes | 140 |
| 13 | X1 | 60 | Yes | 197 |
| Comp. Ex1 | X6 | 10 | No | 102 |
| Comp. Ex2 | None | 0 | NA | 116 |

TABLE 3
Elongation of different latex compositions

| Example | % Elongation |
|---|---|
| 6 | 940 |
| 7 | 572 |
| 8 | 655 |
| 9 | 589 |
| 10 | 763 |
| 11 | 339 |
| Comp. Ex1 | 189 |
| Comp. Ex2 | 256 |

The organo-functional silicone monomer reported in Table 1 were dispersible in water. Water dispersibility was tested by mixing 1 part of monomer and 2 parts of water. The monomer was considered water dispersible where no layer separation was observed and homogenous mixture was obtained. The dispersibility of the monomers in accordance with the present technology was aiding the emulsion polymerization process. Table 2 presents the water dispersibility of silicone acrylate monomer at different loadings, demonstrating effective emulsion polymerization even at higher concentrations. The elongation of the neat latex examples, effectively having a pigment volume concentration (PVC) of 0%, was also measured using ASTM D6083 and reported in Table 3, which shows significant improvement when compared with the comparative examples. Tg values for examples 6-11 and comparative examples were approximately 10-15° C.

### Coatings Formulation and Testing

Coating formulations were prepared using the recipe shown in Table 4, using a pigment volume concentration (PVC) of approximately 35%. Initially, the water-dispersing agent and wetting agent were introduced and thoroughly mixed under slow agitation in a Cowles mixer, followed by the addition of a defoamer, also under slow stirring conditions. While maintaining slow mixing, the pigments and fillers were incorporated, after which the disperser speed was increased to 2000 rpm to ensure optimal dispersion. Subsequently, anti-settling agents and biocides were added to the mixture. The milling or grinding operation was continued for a duration of approximately 40-45 minutes, with periodic monitoring to achieve the target particle size as determined by the Hegman gauge. Upon reaching the specified particle size, the resultant millbase was advanced to the let-down stage.

At this stage, the millbase was combined with water and resin and subjected to propeller agitation for 15-20 minutes. Additional ingredients were sequentially introduced with continuous stirring to promote uniformity. Performance additives and biocides were then incorporated and blended for an additional 5-10 minutes. Thickeners were subsequently added, and the agitation speed was increased to a range of 600-800 rpm, with blending continued for 30 minutes until homogeneity was achieved. The process concluded once the formulation attained the desired viscosity and pH, at which point the paint was filtered and transferred for subsequent use.

TABLE 4
Coating recipes.

| | | | |
|---|---|---|---|
| Ingredient | Function | Supplier | gm |

Mill Base

| | | | |
|---|---|---|---|
| Water 1 | | | 6.86 |
| Ethylene Glycol | | Merck | 0.74 |
| Dispex 4143 | Wetting Agent | BASF | 0.49 |
| Dispex 4480 | Dispersing Agent | BASF | 0.20 |
| Foamstar MO2150 | Defoamer | BASF | 0.20 |
| Titanium dioxide R706 | Pigment | Chemours | 4.90 |
| Calcium carbonate 1P | Extender | Omyacarb | 27.45 |
| Calcium carbonate 5P | Extender | Omyabarb | 9.80 |
| Jubithione ZPTO | Biocide | Jubiliant Ingevia | 1.76 |
| BYK 420 | Anti settling | BYK | 0.39 |
| | agent | | |
| AMP 95 | pH adjuster | Angus chemicals | 0.39 |

Let Down

| | | | |
|---|---|---|---|
| Water II | | | 3.92 |
| Tafigel PU 85 | HEUR thickner | Munzing Chemie | 1.18 |
| Binder/Latex | Film former | | 34.22 |
| Texanol | Coalescent | Merck | 0.98 |
| Foamstar MO 2150 | Defoamer | BASF | 0.20 |
| Foamstar SI 2240 | Defoamer | BASF | 0.10 |
| Silquest A187 | Adhesion | Momentive | 0.15 |
| | Promotor | Performance | |
| | | Materials | |
| Proxel BD 20 | Biocide | Lonza | 0.10 |
| Aquaflow NLS 220 | HEUR thickener | Ashland | 0.98 |

| | |
|---|---|
| Total | 100.00 |

The above recipe was followed for formulation Comparative Examples 3-4, and Examples 14-16 using the different, respective latexes as shown in Table 5. The 33 Elongation of the coating film was measured as per ASTM D 6083 and is reported in Table 5. Examples 14-16 showed significantly higher elongation in comparison with Comparative Examples.

TABLE 5
Coatings Formulations and test results

| Paint Formulation | Latex Composition | % Elongation |
|---|---|---|
| Comparative Example 3 | Comp Ex 1 | 25 |
| Comparative Example 4 | Comp Ex 2 | 33 |
| Example 14 | Example 6 | 85 |
| Example 15 | Example 6 + Comp. Example | 75 |
| | 2 (1:1) | |
| Example 16 | Example 6 + Comp. Example | 52 |
| | 2 (0.25:0.75) | |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an acrylate-functional silicone, a composition comprising the same, copolymers thereof, and a latex formed from the same. Modifications may occur to those skilled in the art and to those who may make and use the invention. The disclosed embodiments are merely for illustrative purposes and not intended to limit the scope of the invention or the subject matter set forth in the claims.

What is claimed is:

1. An organo-functional silicone monomer of the formula (I): 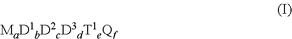
where:
M is R¹(R²)R³)SiO_{1/2}
D¹ is (R⁴)(R⁵)SiO_{2/2}
D² is (R⁶)(R⁷)SiO_{2/2}
D³ is (R⁸)(R⁹)SiO_{2/2}
T¹ is (R¹⁰)SiO_{3/2}
Q is SiO_{4/2}
R¹, R², R³, R⁴, R⁵, R⁶, and R⁸ are independently selected from a C1-C200 hydrocarbon, which optionally may have a heteroatom substituted for one or more of the hydrogen atoms;
R⁷ is a group —R¹¹—O—C(O)—C(R¹²)═CH₂, where R¹¹ is a C2-C100 hydrocarbon optionally substituted with one or more heteroatoms, and R¹² is H or a C1-C10 hydrocarbon;
R⁹ is a polyoxyalkyelene group —R¹³—O—(C₂H₄O)_{g}(C₃H₆O)ₕ(C₄H₈O)ᵢ—R¹⁴ where R¹³ is a C1-C50 hydrocarbon, and R¹⁴ is H or a C1-C10 hydrocarbon;
R¹⁰ is selected from hydrocarbon having 1 to 200 carbon atoms, which optionally may have a heteroatom substituted for one or more of the hydrogen atoms; R⁷; or R⁹;
a, b, c, and d are individually positive integers of from 1 to about 100;
e is 0 to about 100, with the proviso that when R¹⁰ is R⁷, e is 1 and c is 0;
f is 0 to about 100;
g is 1 to about 100; and
h and i are individually 0 to about 100.

2. The organo-functional silicone of claim 1, wherein R¹, R², R³, R⁴, R⁵, R⁶, and R⁸ are independently selected form a C1-C30 alkyl, a C6-C30 aryl, or a C7-C30 aralkyl.

3. The organo-functional silicone of claim 1, wherein R¹, R², R³, R⁴, R⁵, R⁶, and R⁸ are each independently selected from a C1-C10 alkyl.

4. The organo-functional silicone of claim 1, wherein R¹¹ has a structure —R¹⁵—R¹⁶—, where R¹⁵ is a divalent C2-C20 alkyl, and R¹⁶ is a divalent C5-C20 cyclic alkyl group.

5. The organo-functional silicone of claim 4, wherein R¹⁶ is a hydroxy functional divalent cyclohexyl group.

6. The organo-functional silicone of claim 1, wherein R¹¹ is selected from a C2-C20 alkyl.

7. The organo-functional silicone of claim 6, wherein R¹² is H or methyl.

8. The organo-functional silicone of claim 1, wherein h and i are each 0.

9. The organo-functional silicone of claim 1, wherein R¹⁴ is methyl.

10. The organo-functional silicone of claim 1, wherein c is 1-100.

11. The organo-functional silicone of claim 1, wherein c is 1-10.

12. The organo-functional silicone of claim 1, wherein c is 1-2.

13. The organo-functional silicone of claim 1, wherein the ratio of d*g to c is 1:1 or greater.

14. The organo-functional silicone of claim 1, wherein the ratio of d*g to c is from 1:1 to 100:1.

15. The organo-functional silicone of claim 1, wherein a is 2; b is 1-100; c is 1; d is 1-100; and e and f are 0.

16. The organo-functional silicone of claim 1, wherein D¹_{b} is selected from D^{1′}_{b′} and D^{1″}_{b″} where D^{1′}_{b′} is selected from (R^{4′})(R^{5′})SiO_{2/2} where R^{4′} and R^{5′} are a C1-C3 alkyl, and D^{1″}_{b″} is selected from (R^{4″})(R^{5″})SiO_{2/2} where R^{4″} is a C1-C3 alkyl, and R^{5″} is a C4-C20 alkyl, b′ is 1-100 and b″ is 1-100.

17. The organo-functional silicone of claim 16, wherein R^{4′} and R^{5′} are a C1-C3 alkyl, R^{4″} is a C1-C3 alkyl, and R^{5″} is a C4-C10 alkyl, b′ is 1-20 and b″ is 1-20.

18. The organo-functional silicone of claim 16, wherein R^{4′}, R^{5′}, and R^{4″} are each methyl, R^{5″} is a C4-C10 alkyl, b′ is 1-20 and b″ is 1-20.

19. The organo-functional silicone of claim 1, wherein the organo-functional silicone is water dispersible.

20. A composition comprising:
(a) one or more organo-functional silicone of any of claim 1; and
(b) optionally one or more free-radical polymerizable organic monomers; and
(c) water.

21. The composition of claim 20 comprising the one or more free-radical polymerizable monomers (b).

22. A latex copolymer formed from the composition of claim 20.

23. The latex of claim 22 having an average particle size of from about 1 nm to about 10 microns.

24. The latex of claim 22, wherein the ratio of (a) to (b) is 99.9 to 0.1 to about 1 to 99.

25. The latex of any of claim 22, wherein the latex has an elongation of 300% or greater measured according to ASTM D6083.

26. The latex of any of claim 22, wherein the latex has an elongation of from 300% to about 1000% measured according to ASTM D6083.

27. A method of forming a latex by the emulsion polymerization of (a) an organo-functional silicone monomer of any of claim 1, and (b) optionally one or more free-radical polymerizable organic monomers.

28. The method of claim 26, wherein the polymerization is catalyzed by an initiator.

29. A coating, adhesive, or sealant composition comprising the latex of claim 20.

30. The coating composition of claim 29 comprising one or more of a filler, a pigment, a wetting agent, a dispersing agent, a rheology modifier, an anti-cratering agent, a biocides, a coalescent, a cosolvent, a curing agent, a silane, a silicone/siloxane, a defoamers, a fungicide, a heat stabilizer, a leveling agent, a light stabilizer, a mildewcide, an optical brightener, a preservative, a surfactant, an ultraviolet light absorber, a wax, a non-silicone binder, or a mixture of two or more thereof.

31. The coating composition of claim 30 having a pigment volume concentration of from about 0 to about 60%.

32. The coating composition of claim 30 having a pigment volume concentration of from about 20% to about 40%.

33. The coating composition of claim 30 having an elongation of 50% or greater as measured by ASTM D 6083.

34. The coating composition of claim 30 having an elongation of 50% to about 1000% as measured by ASTM D 6083.

35. The coating composition of claim 30 having an elongation of 50% to about 300% as measured by ASTM D 6083.
